(19) United States
(12) Patent Application Publication
(10) Pub. No.: US 2009/0283357 A1
(43) Pub. Date: Nov. 19, 2009

(54) ADJUSTABLE TUBULAR NVH DAMPER AND TORSION ABSORBER

(75) Inventors: Paul Chahine, Dacula, GA (US); Rolf Janssen, Atlanta, GA (US)

Correspondence Address: WOOD, HERRON & EVANS, LLP, 2700 CAREW TOWER, 441 VINE STREET, CINCINNATI, OH, 45202, US

(73) Assignee: American Boa, Inc., Cumming, GA (US)

(21) Appl. No.: 12/464,277

(22) Filed: May 12, 2009

Related U.S. Application Data
(60) Provisional application No. 61/052,664, filed on May 13, 2008.

(51) Int. Cl. F16F 15/00

(52) U.S. Cl. 181/207

(57) ABSTRACT

Respectively tapered and threaded pipe ends are rotated respective to each other to connect the pipe ends and progressively compress a yieldable damper sleeve therebetween as the pipes are rotated. NVH and torsional forces from one pipe end to another are suppressed.

### RELATED APPLICATION

Applicant claims the benefit of U.S. provisional patent application Ser. No. 61/052,664 filed May 13, 2008 and entitled “Adjustable Tubular NVH Dampener and Torsion Absorber” which application is herein incorporated by reference.

### FIELD OF THE INVENTION

This invention relates to the coupling of pipes or conduits used in a piping system and more particularly to apparatus and methods for damping noise, vibration and harshness (NVH) and torsional forces transferred from one pipe coupled to another.

### BACKGROUND OF THE INVENTION

It is known to connect a male tapered-down externally threaded portion of one pipe by rotating it into a flared internally threaded female end of another pipe. While this couples the two pipes together, NVH and torsional forces are transmitted across this coupled area from one pipe to the other.

Existing prior devices provide damping between two pipes via cushion material, but the systems with which such damping devices are used have their own range of vibration noise and harshness parameters. Frequencies vary significantly between systems, such that a damper and torsional absorber optimized for one system will not be so efficient for another.

It is accordingly desired to provide coupling apparatus and methods for securing a variety of respective male and female pipe ends together while, at the same time, suppressing or diminishing NVH and torsional forces transmitted from one pipe to the other.

### SUMMARY OF THE INVENTION

To these ends, a preferred embodiment of the invention contemplates a coupling area with internal and external threads on respective female and male pipe ends in a relationship where a gap between the threads diminishes as the coupling is formed and compresses a damper insert of yieldable damper material therebetween the overlap of pipe ends at the coupled area. The coupling so provided can be adjusted to preload the damper and adjust the suppression characteristics of the coupling to the pipe system being coupled together.

With more particularity, the taper angle of the threaded portion of the respective pipe ends and the pitch of threads is selected so the gap size formed between the respective threads is reduced at a different rate compared to the amount respective rotation of the pipe ends. Taper angle and thread pitch are thus combined to produce a desired damper preload on the damper sleeve between the respective pipe ends. That preload then determines the degree of joint stiffness and friction characteristics of the coupling area and therefore its damping rate. Compensation is thus provided for NVH and torsion damping and deflection in an adjustable structure and for a variety of pipe systems.

Thus, the invention contemplates a semi-flexible connection with variable and highly progressive friction damping for pipes subject to vibration transmission, to torsional loads, or both. This friction damping suppresses or reduces resonance nodes and compensates for NVH. This invention thus integrates the connection of the ends of two tubular fluid conduits. The ends are formed in a tapered shape in which one male pipe end is tapered, featuring a diameter reduction, and the other receiving female pipe end is tapered outwardly with increasing diameter. In order to hold the connection in place, the invention contemplates a damping sleeve disposed between the pipe ends and the respective threads thereof. The damper is preloaded as a function of the amount of relative pipe rotation.

These and other objects and advantages will become readily apparent from the following written description and from the drawings in which:

### BRIEF DESCRIPTION OF THE DRAWINGS

FIG. 1 is an isometric view of an assembled adjustable tubular NVH dampener according to the invention;

FIG. 1A is a exploded isometric view of the invention of FIG. 1 with the matting/damping/cushion material illustrated between two pipe ends;

FIG. 1B is a cross-section view of the invention as shown in FIG. 1 with the matting/damping/cushion between the pipe ends; and

FIG. 1C is an enlarged view of the highlighted portion of FIG. 1B, showing features of the invention in more detail.

### DETAILED DESCRIPTION OF THE INVENTION

It should be readily understood that the components and steps of the invention, as generally described and illustrated in the Figures herein and accompanying text, can be arranged and designed in a wide variety of different configurations while still utilizing the inventive concept. Thus, the following more detailed description of the preferred embodiments of the system and method for the present invention, as presented in the Figures and accompanying text, is not intended to limit the scope of the invention, but it is merely representative of the presently preferred embodiments of the invention.

The preferred embodiments of the invention will be best understood by reference to the drawings wherein like parts or steps are designated by like numerals.

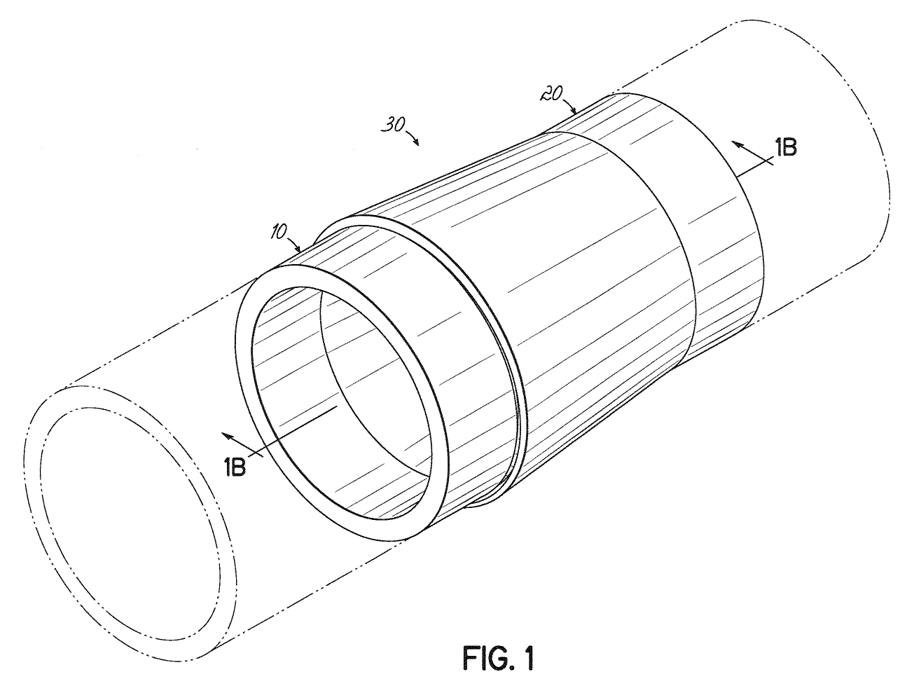

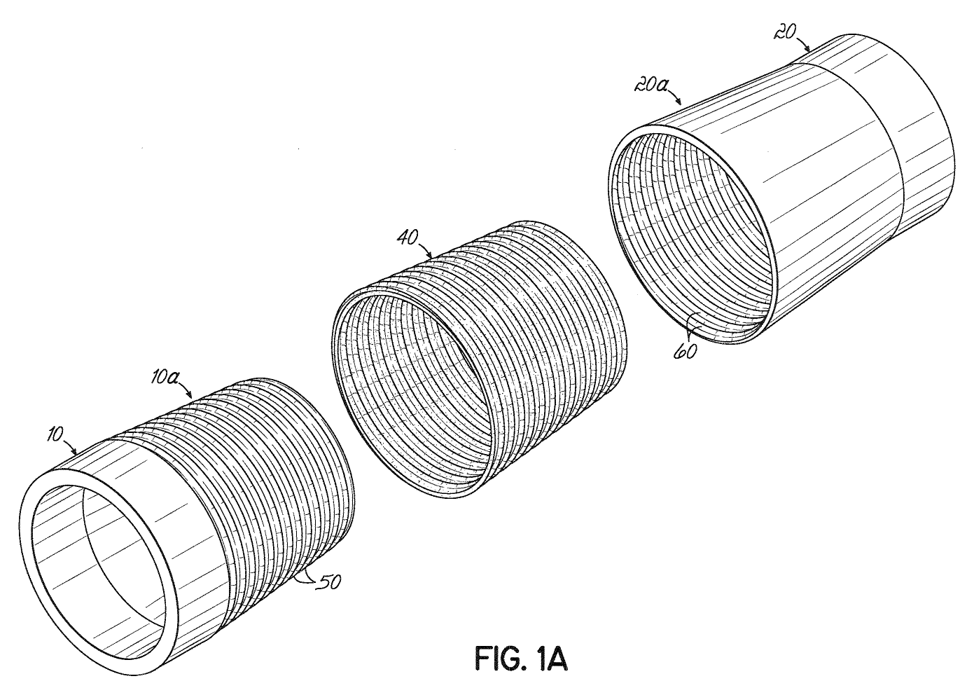

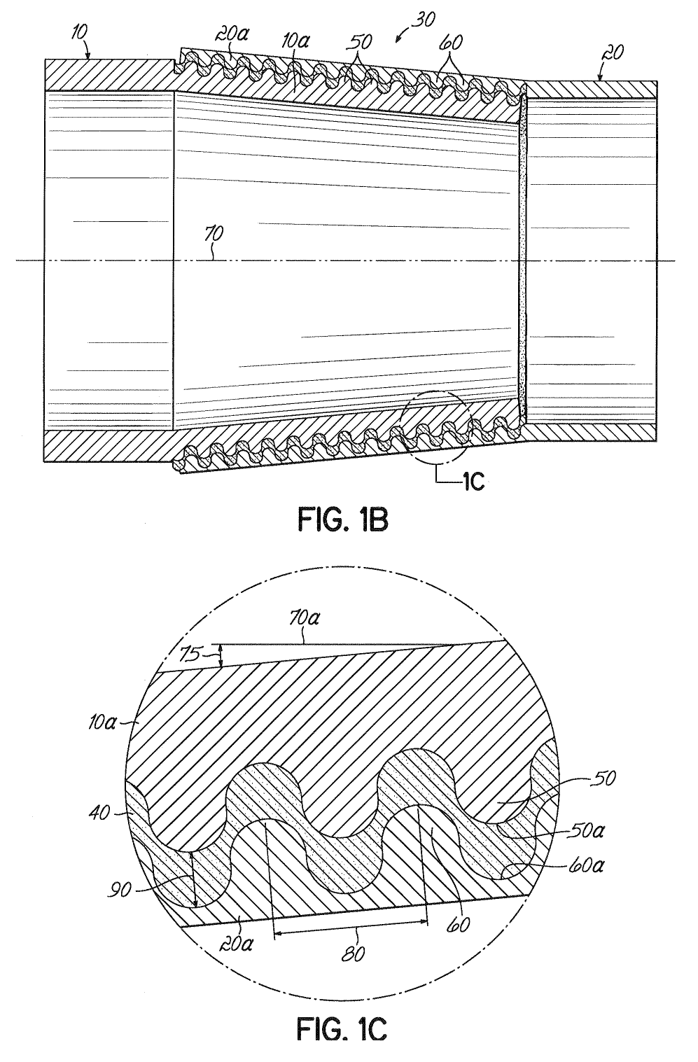

Referring now to FIG. 1, there is disclosed therein an illustrative view of the two respective pipes 10, 20, coupled together in a coupling zone identified at 30.

FIG. 1A illustrates in exploded form the respective pipe ends 10a, 20a and the damping insert 40 which is not shown in FIG. 1. Pipe end 10a is a radially inwardly tapered male pipe end having external threads 50 therealong. Pipe end 20a is a radially outwardly flared female end having internal threads 60 therein.

Damping insert 40 is a sleeve which may preferably be slightly tapered similarly to pipe ends 10a, 20a. Sleeve 40 may also be supplied with external and internal threading similar to that of the pipe ends 10a, 20a. in use, when the pipes 10, 20 are coupled as in FIG. 1, damping insert 40 resides between ends 10a, 20a, as will be described.

Turning now to FIGS. 1B and 1C, the details of the threaded ends 10a, 20a will be described. FIG. 1B is a cross-sectional view showing the relation of male end 10a to female end 20a. External threads 50 on male end 10a loosely mesh, or are indexed therewith, internal threads 60 of female end 20a and about axis 70, pipes 10 and 20 being essentially coaxial. It will be appreciated that the outermost portion of flared end 20a is about the same outer diameter of that of pipe 10. The innermost tapered portion of end 10a is about the same inner diameter of pipe 20. These dimensions may be closer to each other or further apart as desired. In any event, it will be appreciated that end 10a can be rotatably threaded into end 20a.

FIG. 1C illustrates in enlarged view for clarity that selected portion of FIG. 1B. FIG. 1C further illustrates the relation of components of the invention. First, it will be appreciated that angle 75 is a taper angle illustrating the angle of taper between the inwardly tapered end 10a of pipe 10 and an arbitrary line 70a which is a parallel to axis 70. Both ends 10a and 20a are preferably disposed on this taper angle.

It will also be appreciated that the threads 50 and 60 have a pitch illustrated by the line 80 in FIG. 1C, and that when the pipe ends 10a, 20a are rotated respectively, an undulating gap 90 is formed between the projecting portions 50a of threads 50 and concave portions 60a of threads 60. Gap 90 is undulating and varies in width as it extends along and between threaded portions 50 and 60.

The damping member 40 is disposed over end 10a and fits within end 20a, such that it resides in gap 90 between threads 50 and 60. As the pipes 10, 20 are respectively counter-rotated, end 10a is threaded into end 20a, with the respective threads engaging to compress damper 40 between ends 10a, 20a.

Referring to the Figures above, FIG. 1 illustrates two tube ends 10 and 20, connected via the threaded area 30 (defined by male 50 and female 60 tapered threads) (FIG. 1A) to enclose the matting/damping/cushion material 40.

By relatively rotating the tubes 10 and 20 in opposite directions the gap 90 between the respective threads (FIG. 1C) is increasingly reduced. Depending on the taper angle 75 and the pitch 80 of the threads 50, 60, the gap 90 size is reduced in a different rate compared to the amount of rotation. The gap 90 captures the damping or cushion material 40. By reducing the gap with turning of the threads, the cushion material 40 is progressively compressed or preloaded. Again the taper angle 75 and the thread pitch 80 determine the force or preload that is applied to the damping or cushion material 40. In turn, the preload determines the stiffness and friction characteristics of the connection and therefore its dampening rate.

It will be appreciated that the tapered threads 50, 60, upon progressing rotation of ends 10a, 20a, come respectively closer and closer together, narrowing gap 90 and further compressing the intermediate damper sleeve 40. Thus, the undesirable frequencies and NVH parameters of the system can be damped from system to system without specific design or construction features requiring different mechanisms for optimal damping.

Alternately, relative thread pitch of threads 50, 60, type of thread and taper angle can all be adjusted or varied as desired.

This invention contemplates an adjustable structure that can be adapted to problematic modes of specific applications. Unlike prior devices, it additionally allows for torsional dampening and torsional deflection compensation.

The invention is made with a variety of materials and thicknesses of the materials for conical tubular structure. The damper may comprise one or multiple plies of various types and shapes of cushion material. In addition to the NVH damping benefits the present invention can improve assembly ease for complex piping systems.

Materials for both pipes, threaded ends and cushion are selected from any suitable synthetic or other suitable types or compositions.

Finally, it will be appreciated that the tolerances and depiction of the components of the invention as shown in the Figures are for clarity of illustration only, and are not to scale, and actual tolerances may vary.

Thus, in conjunction with one or more torsion absorbers or coupling areas according to the invention, the aggressive dynamic modes of harshness, noise and vibrations (NVH) existent in a sensitive tubular system can be manipulated for under or over critical behavior and torsional loads can be absorbed.

These and other alternatives, modifications and advantages will become readily apparent to those of ordinary skill in the field to which this invention pertains and applicant intends to be bound only by the claims appended hereto.

What is claimed is:

1. A vibration damper for use in a pipe system including two respective pipe ends, each having: one of a tapered female or male thread, and a sleeve shaped cushion disposed between said respective threads when said pipe ends are threaded together.

2. A damper as in claim 1 wherein said cushion is threaded.

3. A damper as in claim 1 wherein progressive rotation threading one pipe end to another progressively compresses said cushion.

4. A damper as in claim 1 including a gap between said respective threads, said gap decreasing progressively in width as one of said pipe ends is rotated into the other.

5. A method for damping parameters in a pipe system having two pipe ends, each having one of a tapered male or a tapered female thread, the method comprising the combination of the steps of:
the step of inserting between said respective threads a sleeve-shaped cushioning damper; and
rotating the two pipe ends relative to each other and connecting said ends by operative orientation and cooperation of respective male and female tapered threads in respective ones of said ends.

6. A method as in claim 4 including the step of progressively decreasing space between respective threads of said pipe ends by relative rotation thereof and compressing said damper.
